(19) United States
(12) Patent Application Publication
(10) Pub. No.: US 2004/0093566 A1
(43) Pub. Date: May 13, 2004

(54) Method and software product for inserting author related information into electronic mail messages

(76) Inventor: Adrian Edwin McElligott, Durack (AU)

Correspondence Address: CONLEY ROSE, P.C., P. O. BOX 3267, HOUSTON, TX, 77253-3267, US

(21) Appl. No.: 10/701,809

(22) Filed: Nov. 5, 2003

Related U.S. Application Data
(60) Provisional application No. 60/426,069, filed on Nov. 12, 2002.

(51) Int. Cl. G06F 17/00

(52) U.S. Cl. 715/531

(57) ABSTRACT

A method for processing an email message includes the steps of obtaining originator data from the email message that is indicative of the message's origin. Additional data, such as the geographical location at which the email message was created is then retrieved from a database on the basis of the originator data. The additional data is added to the “From” field of the email address that is finally read by the intended recipient. Consequently, when replying to the email a response may be sent which takes into account the additional data and so is more appropriate than might otherwise be the case. An intended application of the method is in processing emails to a business in order to improve the likelihood of responding with messages that might produce a sale.

### CROSS-REFERENCE TO RELATED APPLICATIONS

This application claims benefit from provisional application Serial No. 60/426,069 filed Nov. 12, 2002, which is incorporated by reference herein as if reproduced in full below.

### STATEMENT REGARDING FEDERALLY SPONSORED RESEARCH OR DEVELOPMENT

Not applicable.

### FIELD OF THE INVENTION

The present invention is concerned with the processing of electronic mail messages. In a particular application the invention is concerned with a method for intercepting and processing e-mail messages so that a reader of the message is conveniently provided with additional information relating to the author of the message.

### BACKGROUND TO THE INVENTION

Since the advent of the Internet, the popularity of electronic mail (e-mail) has grown to the point where it is now widely used for both personal and business communication. Electronic mail has become a significant first point of contact between businesses and new clients. However it is often difficult for businesses to maximize the potential that new electronic mail messages present. This is because electronic mail inquiries commonly have very little contextual information about the author that would assist the business to obtain a return from the e-mail inquiry in the form of, for example, a sale.

Consequently there is a need for an aid to assist businesses to maximize returns from e-mail message inquiries.

It is an object of the present invention to provide a method for processing emails so that the recipient of the e-mail is presented with information related to the author of the message in addition to the electronic mail message itself.

### SUMMARY OF THE INVENTION

According to a first aspect of the present invention there is provided a method for processing an electronic mail message comprising the steps of:

obtaining originator data indicating the origin of an electronic mail message;

obtaining additional data from an information source on the basis of the originator data; and

inserting the additional data into the electronic mail message for presentation to a recipient of said message.

In a preferred embodiment of the invention the originator data comprises an IP Address associated with a workstation upon which said message was authored.

The originator data may be obtained by processing the electronic mail message.

Alternatively, the originator data may be obtained from a parameter of a data connection to the workstation.

Typically the additional data comprises a name of a geographical region corresponding to the IP Address.

The step of obtaining originator data from a field of the electronic mail message may be performed at a workstation of a recipient of the electronic message.

Alternatively, the step of obtaining the originator data is performed at a network computational device located between a workstation of the recipient and a workstation upon which said message was authored.

The network computational device may, for example, comprise any one of: a post office server, a firewall, a router, a gateway.

According to a further embodiment of the present invention there is provided an e-mail pre-processing computer software product stored on a computer readable medium, said product containing instructions for execution by an electronic processor, the instructions including:

instructions for obtaining originator data of an electronic mail message;

instructions for obtaining additional data from a data source on the basis of the originator data; and

instructions for inserting the additional data into the electronic mail message for presentation to a recipient.

Preferably the instructions for obtaining originator data include instructions for processing the electronic mail message to obtain an IP Address associated with a workstation upon which said message was authored.

Alternatively, the instructions for obtaining originator data may include instructions for obtaining an IP Address associated with the workstation upon which said message was authored from a parameter of a connection to said workstation.

It is preferable that the software product be configured for execution on a TCP/IP stack of a network computational device.

Other preferred features of the invention will be apparent from the following detailed description wherein preferred embodiments of the invention will be explained in relation to a number of drawings.

### BRIEF DESCRIPTION OF THE DRAWINGS

In order that this invention may be more readily understood and put into practical effect, reference will now be made to the accompanying drawings wherein:

FIG. 1 is a schematic diagram used to explain the operation of an embodiment of the present invention.

FIG. 2 is a schematic diagram used to explain the operation of a further embodiment of the present invention.

FIG. 3 illustrates the interfacing of a software product according to an embodiment of the present invention, running on a network computational device such as a post office server.

FIG. 4 is a flowchart illustrating the operational steps of a software product according to an embodiment of the invention.

FIG. 5 is a schematic diagram illustrating the operation of a further embodiment of the present invention.

FIG. 6 illustrates the interfacing of a software product according to an embodiment of the present invention, running on a recipient's workstation.

### DETAILED DESCRIPTION OF PREFERRED EMBODIMENT

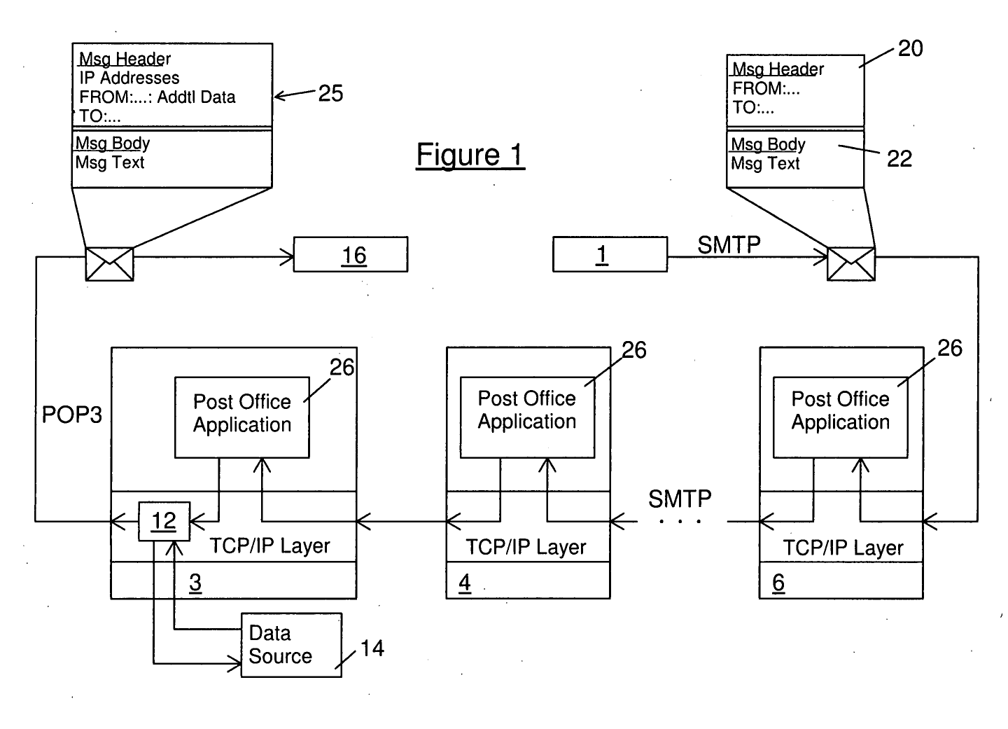

FIG. 1 depicts an author workstation 1 which is able to author an electronic mail message 5 and to transmit it, for example by means of an Internet connection, to a first post office server 6. The term “post office server” is used to refer to a network computational device which runs a post office application. Such an application typically includes instructions for relaying and storing e-mail messages.

According to the SMTP protocol e-mail message 5 contains a header 20 and message body 22. Message header 20 contains the e-mail address of an e-mail account of the message's author. The e-mail address is, for example, in the form of AuthorName@AuthorISP.com and usually appears in the FROM field of the e-mail message when it is finally displayed upon the recipient's workstation 16. The message also includes a TO field which contains the e-mail address of the intended recipient of the message. Message 5 is typically relayed over one or more network devices, for example post office servers 6 and 4, until it reaches post office server 3. post office server 3 has a mail account and directory, or “mailbox” corresponding to the e-mail address of the intended recipient. The message is stored on post office server 3 for subsequent retrieval by its intended recipient by means of a remote workstation, for example workstation 16 in accordance with the POP3 protocol.

In the example depicted in FIG. 1 the first post office server to process message 5 is post office server 6. Post office server 6 determines originator data in the form of the IP Address of workstation 1 from its connection with workstation 1. That is, post office server 6 operates according to software which contains instructions to retrieve the IP Address of workstation 1 from the TCP/IP parameters of the connection between itself and workstation 1. The originator data indicates the origin of message 5. Post office server 6 inserts the IP Address of the author workstation into message header 20. Subsequently post office server 4 receives message 5 and appends the IP Address of the post office server which passed the message. Similarly post office 3 appends the IP Address of post office 4 to the message. The net result is that the header of message 5 contains multiple IP Addresses, one for the originating workstation 1 and one for each of the transient post offices through which the message is passed.

Transmission of electronic mail messages from one post office server to another, and from client workstation 1 to post office Server 3, is typically in accordance with the Simple Mail Transport Protocol (SMTP). The SMTP is described in RFC 822. Other mail transport protocols are also known such as X.400. The present invention is described in relation to SMTP and POP3 protocols but is not limited in applicability to any one transport system.

In the preferred embodiment of the present invention, message 5 is intercepted by an e-mail pre-processing application 12 after being passed to post office application 26. In the embodiment depicted in FIG. 1 the E-mail preprocessing application 12 is located downstream of post office application 26 on post office server 3. However, pre-processing application 12 may also be resident on any of the post office servers and either upstream or downstream of post office application 26. The pre-processing application obtains the IP Address of workstation 1 at least two ways.

Firstly, if application 12 is located either downstream of post office application 26 on server 6, as shown in FIG. 1, or on any of the other post office servers, then the IP Address of workstation 1 may be obtained from message header 20, for example by parsing it according to standard techniques.

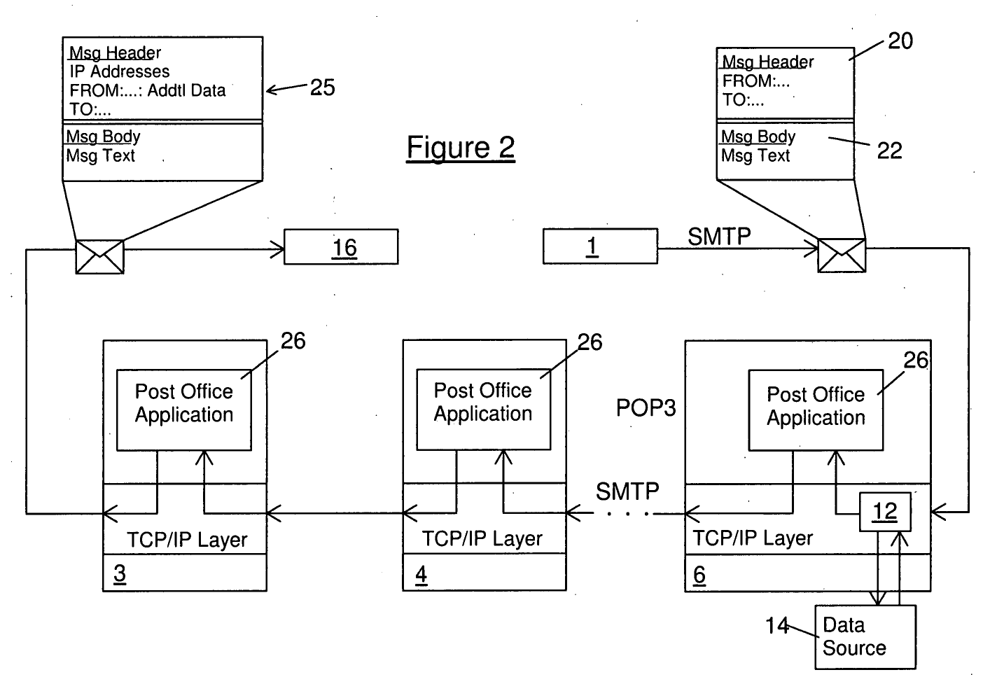

Secondly, with reference to FIG. 2, where application 12 is located upstream of post office application 26 on the first post office server, i.e. server 6, then the IP Address of workstation 1 may be obtained from a parameter of the TCP/IP connection between server 6 and workstation 1.

On the basis of the determined IP Address, pre-processing application 12 obtains additional data in the form of the name of a corresponding geographical location from data source 14. The name, which will for example be the name of a city or rural region, is appended to the entry in the FROM field of message header 20. The message is then processed by post office application 26 in standard fashion.

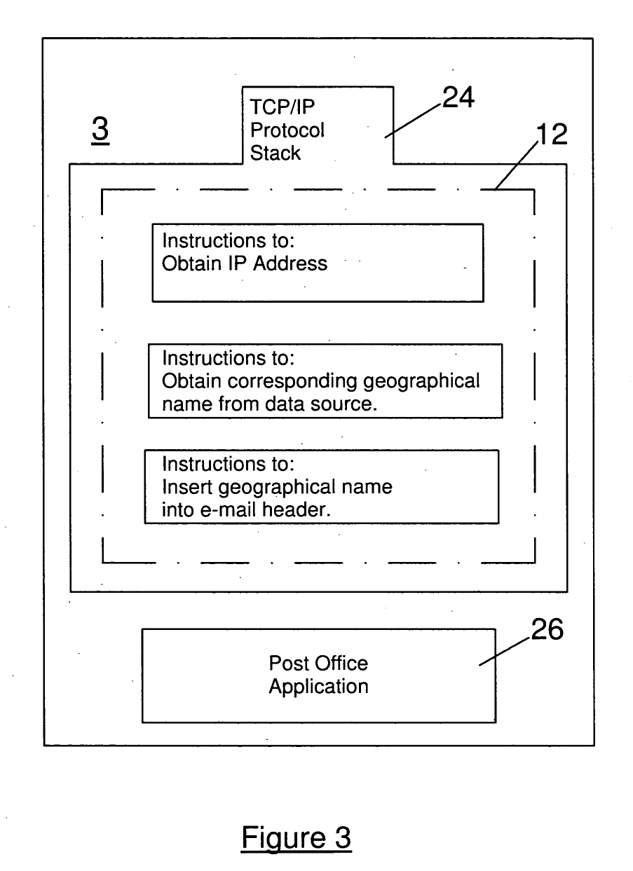

Application 12 preferably resides within the TCP/IP protocol stack of whatever server it is supported upon. For example, FIG. 3 schematically depicts application 12 residing within the TCP/IP protocol stack of server 3 of FIG. 1. Due to its residence in the stack, application 12 is able to intercept POP3 and SMTP transmissions carried by TCP/IP. Application 12 intercepts data passing through the TCP/IP protocol stack in the manner of a protocol layer. The application identifies POP3 and SMTP transmissions by their use of port-110 and port-25 respectively.

Messages processed by application 12 are passed to post office Application 26 via an operating system supplied interface, for example WinSocket API.

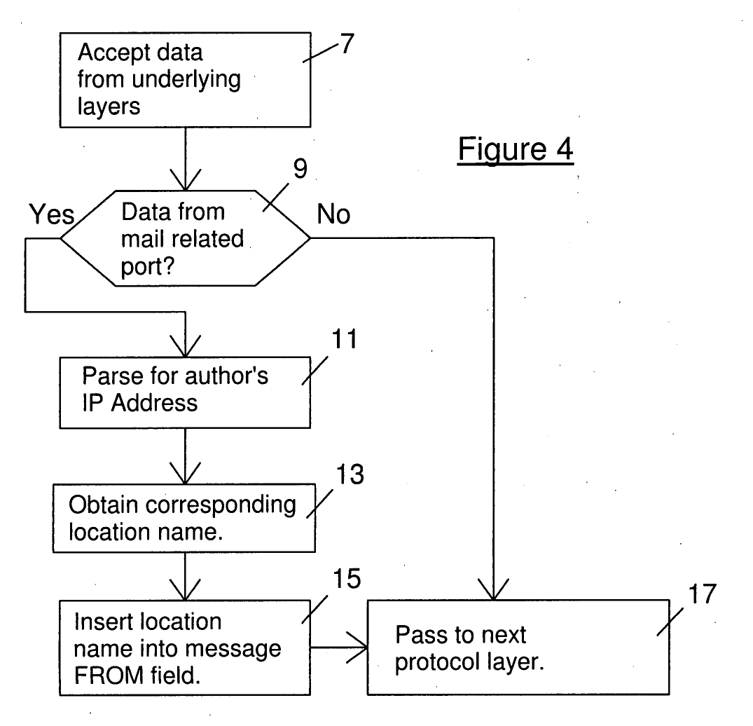

The operational steps of e-mail pre-processing application 12 will now be further explained with reference to the flowchart of FIG. 4. Initially, at box 7 application 12 accepts data from underlying layers, including the underlying TCP/IP layer. At box 9 pre-processing application 12 determines if the data that has been passed pertains to a port concerned with electronic mail data. As previously mentioned, in the case of SMTP and POP3 mail, messaging ports 25 and 110 respectively are used.

At box 11 application 12 parses message header 20 to obtain originator data of the message in the form of the IP Address of the author's workstation. Alternatively, if the pre-processing application 12 is located upstream of post-office application 26 on post office server 6, then the pre-processing application is programmed to obtain the IP Address of workstation 6 from the TCP/IP connection. At box 13 application 12 obtains additional data on the basis of the originator data. In the presently described embodiment the additional data comprises the name of a geographical location corresponding to the author workstation's IP address. The geographical location name may be obtained by reference to a remote data source 14. Data source 14 may be a remote database server for example. Alternatively the geographical location name may be obtained by reference to data held in memory on post office server 3. Methods for determining a geographical location corresponding to an IP Address are described in International Patent Application PCT/AU01/00096 (WO 01/57696) and U.S. patent application Ser. No. 60/380,093 both to the present applicant and both of which are hereby incorporated by cross-reference in their entireties.

At box 15 application 12 amends message header 20 by appending or inserting the geographical location name to the FROM field of the message header.

At box 17 the amended message is passed to a further protocol layer for further processing. In the presently described embodiment, where application 12 is running on a network device that is configured as a post office server, the message is passed to post office application 26. Alternatively, it will be realised that preprocessing application 12 may be resident on network devices other than a post office server. For example the application may be run by a Firewall or Gateway server or indeed any network computational device which supports the transmission of electronic mail messages.

It will be noted that the application operates on the e-mail according to various instructions. Broadly, pre-processing application 12 includes instructions for obtaining originator data, instructions for obtaining additional data from the data source on the basis of the originator data, and instructions for inserting the additional information into the electronic mail messages for presentation to a recipient. The instructions may be stored on a computer readable medium such as a magnetic or optical disk, thereby comprising a computer software product for processing by an electronic processor.

Referring again to FIG. 1, subsequent to operation of application 12, the message is retrieved by reader workstation 16 according to, for example, the POP3 protocol. The retrieved message 25 is displayed on reader workstation 16 by means an e-mail reader application. A popular e-mail reader application is Microsoft Corporation's Outlook program. The displayed message includes the approximate geographical location of the sender of the message, for example, in its FROM field

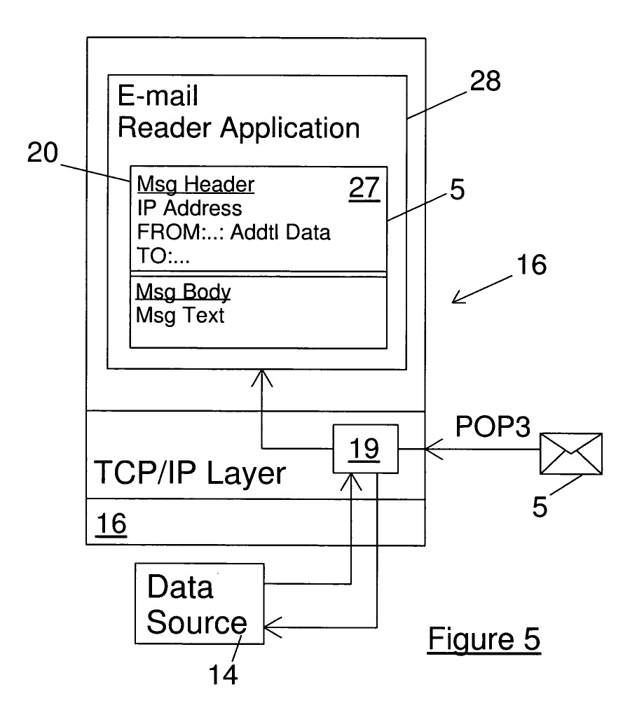

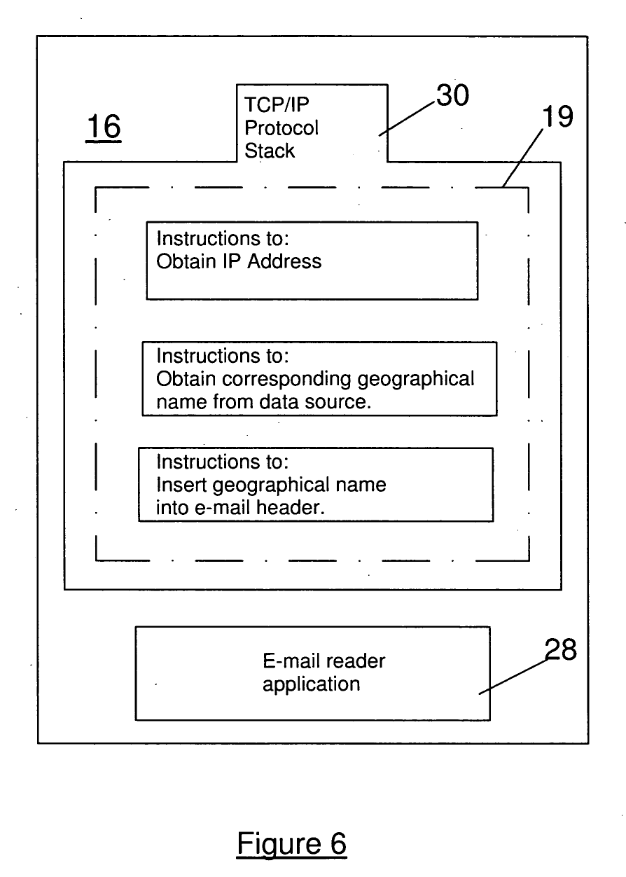

FIG. 5 depicts a further embodiment of the present invention wherein a reader workstation 16 runs a geographical resolving application 19 for pre-processing mail messages retrieved from post office server 3. FIG. 6, schematically shows the interfacing of application 19 between underlying TCP/IP processes 30 and a typical electronic mail reader application 28. Application 19 operates in the same manner as application 12 and in accordance with the flowchart of FIG. 4, except that at box 17 of that figure the e-mail message is passed to e-mail reader application 28 rather than to a post office server application.

E-mail messages that are processed according to the previously described embodiments of the invention present additional data in the form of the name of the approximate geographical location of the author workstation. The additional data is conveniently present in the FROM field of the messages. For example, the FROM field may read AuthorName@AuthorISP.com : New York. Consequently the reader of the e-mail knows that the author resides in New York. Accordingly when replying the response message may be specifically tailored to suit a person living in New York. Such tailoring may involve quoting shipping prices for goods that may be purchased to be shipped to New York or taking into account the climate and habits of residents of that region. Accordingly, the additional information associated with the originator of the message that is inserted into the FROM field, assists businesses in maximising returns from e-mail message inquiries.

It will be realised that the applications 12 and 19 may be configured to process electronic mail messages in other ways apart from determining the geographical location from the IP Address embedded in the message envelope.

The embodiments of the invention described herein are provided for purposes of explaining the principles thereof, and are not to be considered as limiting or restricting the invention since many modifications may be made by the exercise of skill in the art without departing from the scope of the invention as defined in the following claims.

I Claim:

1. A method for processing an electronic mail message comprising the steps of:
obtaining originator data indicating the origin of an electronic mail message;
obtaining additional data from an information source on the basis of the originator data; and
inserting the additional data into the electronic mail message for presentation to a recipient of said message.

2. A method according to claim 1, wherein the originator data comprises an IP Address associated with a workstation upon which said message was authored.

3. A method according to claim 1, wherein the originator data is obtained by processing the electronic mail message.

4. A method according to claim 2, wherein the originator data is obtained from a parameter of a data connection to the workstation.

5. A method according to claim 2, wherein the additional data comprises a name of a geographical region corresponding to the IP Address.

6. A method according to claim 1, wherein the step of obtaining originator data is performed at a workstation of a recipient of the electronic message.

7. A method according to claim 1, wherein the step of obtaining the originator data is performed at a network computational device located between a workstation of the recipient and a workstation upon which said message was authored.

8. A method according to claim 1, wherein the the network computational device comprises any one of: a post office server, a firewall, a router, a gateway.

9. An e-mail pre-processing computer software product stored on a computer readable medium, said product containing instructions for execution by an electronic processor, the instructions including:
instructions for obtaining originator data of an electronic mail message;
instructions for obtaining additional data from a data source on the basis of the originator data; and
instructions for inserting the additional data into the electronic mail message for presentation to a recipient.

10. An e-mail pre-processing computer software product according to claim 9, wherein the instructions for obtaining originator data include instructions for processing the electronic mail message to obtain an IP Address associated with a workstation upon which said message was authored.

11. An e-mail pre-processing computer software product according to claim 9, wherein the instructions for obtaining originator data include instructions for obtaining an IP Address associated with the workstation upon which said message was authored from a parameter of a connection to said workstation.

12. An e-mail pre-processing computer software product according to claim 9 configured for execution on a TCP/IP stack of a network computational device.
